(19) United States
(12) Patent Application Publication
(10) Pub. No.: US 2020/0307523 A1
(43) Pub. Date: Oct. 1, 2020

(54) VEHICLE OPTICAL DEVICE

(71) Applicant: LG ELECTRONICS INC., Seoul (KR)

(72) Inventor: Dongwook KIM, Seoul (KR)

(73) Assignee: LG ELECTRONICS INC., Seoul (KR)

(21) Appl. No.: 16/719,822

(22) Filed: Dec. 18, 2019

Related U.S. Application Data
(60) Provisional application No. 62/747,675, filed on Oct. 19, 2018.

(51) Int. Cl. B60S 1/56; G02B 27/00; B60S 1/48; B60S 1/28; B08B 3/12

(52) U.S. Cl. CPC B60S 1/56; G02B 27/0006; B08B 3/12; B60S 1/28; B60S 1/48

(57) ABSTRACT

A vehicle optical device comprises an optical module including a lens through which external light passes; a cover glass arranged on a front surface of the lens; a motor driving the cover glass; a cleaner for accommodating a portion of the cover glass; and a controller driving the motor to accommodate a portion of the cover glass, which is arranged on the front surface of the lens and contaminated, in the cleaner through rotation of the cover glass if the portion of the cover glass is contaminated. The vehicle optical device may acquire exact information by removing particles that disturb acquisition of external information.

Pursuant to 35 U.S.C. § 119(e), this application claims the benefit of the U.S. Provisional Application No. 62/747,675, filed on Oct. 19, 2018, the contents of which are hereby incorporated by reference herein in its entirety.

### BACKGROUND OF THE INVENTION

### Field of the Invention

The present disclosure relates to a vehicle optical device, and more particularly, to a vehicle optical device having an automatic cleaning function for removing particles such as dust or water drop on a camera lens provided outside a vehicle.

### Discussion of the Related Art

For safety of a vehicle, in addition to a black box camera, a rear camera that allows a user to view an invisible area at the rear of the vehicle is built in the vehicle as a necessity of the vehicle. Recently, a camera for sensing vehicles at the front and a camera for sensing a lane, a signal, etc. are built in the vehicle to assist driving of the vehicle. Moreover, since a camera should be built at front and rear sides and left and right sides of the vehicle for autonomous driving, the number of cameras outside the vehicle is gradually increased.

Since the camera is required to allow light to transmit it, a cover glass of a transparent material is arranged on a front surface of a lens. However, problems occur in that the outside of the vehicle may be contaminated by rain, snow, dust, etc., and the camera arranged at a lower portion of the vehicle may be more contaminated by muddy water.

If a front surface of the camera is contaminated, external information cannot be sensed exactly, whereby the camera may not be operated normally, and the user has a difficulty in always removing contamination manually.

### SUMMARY OF THE INVENTION

Accordingly, the present disclosure is directed to a vehicle optical device that substantially obviates one or more problems due to limitations and disadvantages of the related art.

An object of the present disclosure is to provide a vehicle optical device having a function of automatically cleaning a cover glass on a front surface.

In addition to the objects of the present disclosure as mentioned above, additional objects and features of the present disclosure will be clearly understood by those skilled in the art from the following description of the present disclosure.

To achieve these objects and other advantages and in accordance with the purpose of the invention, as embodied and broadly described herein, there is provided a vehicle optical device comprising an optical module including a lens through which external light passes; a cover glass arranged on a front surface of the lens; a motor driving the cover glass; a cleaner for accommodating a portion of the cover glass; and a controller driving the motor to accommodate a portion of the cover glass, which is arranged on the front surface of the lens and contaminated, in the cleaner through rotation of the cover glass if the portion of the cover glass is contaminated.

The cleaner may include a cleaning solution in which the cover glass is dipped; and an ultrasonic module providing ultrasonic waves to the cleaning solution.

The vehicle optical device may further comprise a wiper arranged to adjoin the cleaner, removing a cleaning solution remaining in the cover glass taken out from the cleaner.

The wiper may be arranged on both a front surface and a rear surface of the cover glass.

The cleaning solution may include a water repellent coating solution.

The vehicle optical device may further comprise a vehicle body panel forming an external appearance of a vehicle, an optical hole formed in the vehicle body panel and formed at a position corresponding to the lens, and a waterproof member arranged between the vehicle body panel and the cover glass, covering a circumference of the optical hole.

The cover glass may have a circular disk shape, the motor may be fixed to a center of the cover glass, the optical module may be arranged to be spaced apart from the center of the cover glass at a first distance, and the cleaner may be arranged within the first distance from the center of the cover glass.

According to the vehicle optical device of the present disclosure, since particles that disturb acquisition of external information are removed, exact information may be acquired.

Also, since a user does not need to clean the vehicle manually, convenience of a driver may be improved.

Since the cover is cleaned using multiple methods, a cleaning effect is high, and the cover may be used semi-permanently.

In addition to the effects of the present disclosure as mentioned above, additional effects and features of the present disclosure will be clearly understood by those skilled in the art from the following description of the present disclosure.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a position where an optical device is packaged in a vehicle.

FIG. 2 is a block view illustrating elements of an optical device;

FIG. 3 is a perspective view illustrating one embodiment of an optical device; and

FIG. 4 illustrates a front view and a plane view illustrating an optical device of FIG. 3.

### DETAILED DESCRIPTION OF THE INVENTION

Reference will now be made in detail to the preferred embodiments of the present specification, examples of which are illustrated in the accompanying drawings. Wherever possible, the same reference numbers will be used throughout the drawings to refer to the same or like parts. The suffixes “module” and “unit” for the elements used in the following description are given or used in common by considering facilitation in writing this disclosure only but fail to have meanings or roles discriminated from each other.

Also, in description of the embodiments disclosed in this specification, if detailed description of the disclosure known in respect of the present disclosure is determined to make the subject matter of the embodiments disclosed in this specification obscure, the detailed description will be omitted.

Also, the accompanying drawings are only intended to facilitate understanding of the embodiments disclosed in this specification, and it is to be understood that technical spirits disclosed in this specification are not limited by the accompanying drawings and the accompanying drawings include all modifications, equivalents or replacements included in technical spirits and technical scope of the present disclosure.

Although the terms such as “first” and/or “second” in this specification may be used to describe various elements, it is to be understood that the elements are not limited by such terms. The terms may be used to identify one element from another element.

The expression that an element is “connected” or “coupled” to another element should be understood that the element may directly be connected or coupled to another element, a third element may be interposed between the corresponding elements, or the corresponding elements may be connected or coupled to each other through a third element. On the other hand, the expression that an element is “directly connected” or “directly coupled” to another element” means that no third element exists therebetween.

It is to be understood that the singular expression used in this specification includes the plural expression unless defined differently on the context.

In this application, it is to be understood that the terms such as “include” and “has” are intended to designate that features, numbers, steps, operations, elements, parts, or their combination, which are disclosed in the specification, exist, and are intended not to previously exclude the presence or optional possibility of one or more other features, numbers, steps, operations, elements, parts, or their combinations.

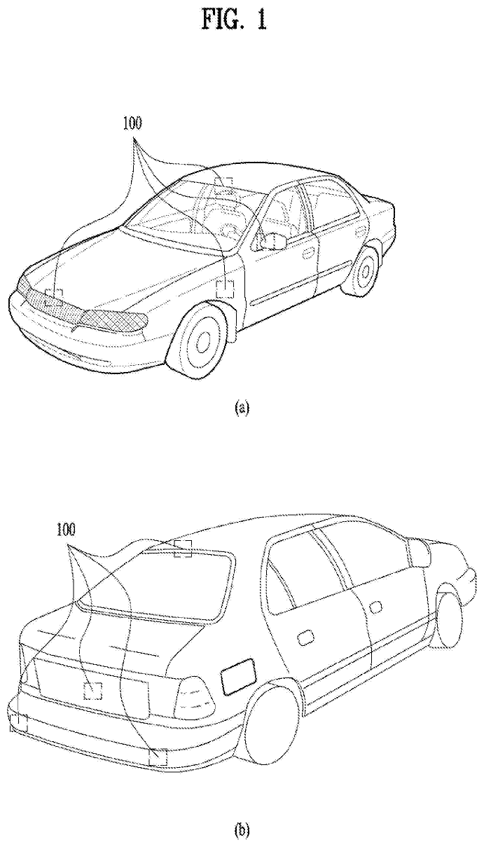

FIG. 1 illustrates a position where an optical device 100 is packaged in a vehicle. As the optical device 100 provided outside the vehicle, there may be a camera. In addition to the camera, examples of the optical device may include a distance sensor, a proximity sensor, and an illumination sensor. The camera is a device for capturing an image, and may record the captured image or output the captured image to a display of the vehicle. The camera may recognize an object by using the captured image. For example, the camera may sense a pedestrian or a neighboring vehicle, and may check a lane. The camera may provide a driver with an image of an invisible area at the rear of the vehicle and widen a view.

A proximity sensor for sensing an object arranged near the vehicle or a distance between vehicles may be provided as one of the optical device 100 of the present disclosure. It is required to sense an exact distance to maintain a distance between autonomous vehicles by using the proximity sensor. The illumination sensor may adjust brightness of information acquired from the camera, etc. by sensing peripheral brightness, and may automatically control setup of a light of a vehicle in accordance with illumination.

As shown in (a) and (b) of FIG. 1, the optical device 100 may be arranged toward the front or at the rear in a side direction, and may be arranged at lower portion or an upper side. Since the optical devices 100 use light, if a place where external light enters is contaminated, a problem occurs in that exactness is reduced. Therefore, the optical device 100 may include a cleaner 141 for cleaning the place where external light enters.

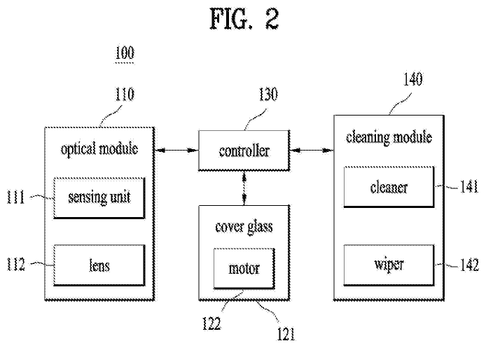

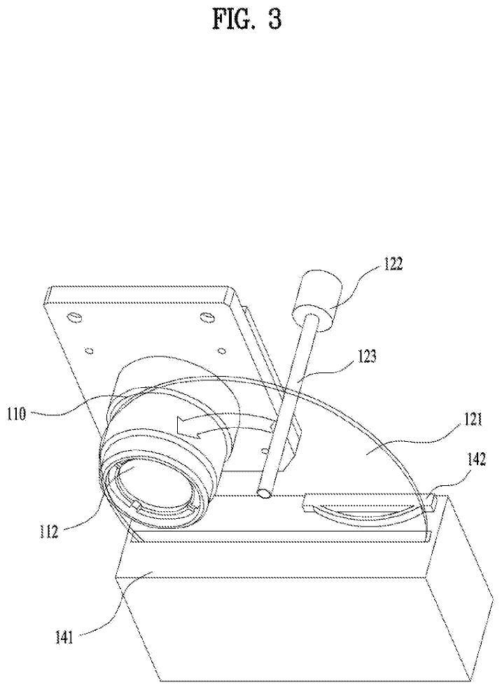

FIG. 2 is a block view illustrating elements of the optical device 100, and FIG. 3 is a perspective view illustrating one embodiment of the optical device 100. The optical device 100 may include an optical module 110, a cover glass 121 arranged on a front surface of the optical module 110, and a cleaning module 140 for cleaning the cover glass 121 to maintain a clean state of the cover glass 121. The optical device 100 may include a controller 130 for controlling each of the optical module, the cover glass and the cleaner.

The optical module 110 may include a sensing unit 111 and a lens 112. The sensing unit 111 is a device for sensing light entering through the lens 112, and includes an image sensor of the camera in addition to an ultrasonic sensor and an infrared sensor. As the lens 112, at least one lens 112 may be arranged, and a position between the lenses 112 may be controlled to control light entering the optical module 110. The cover glass is arranged on the front surface of the optical module 110, and a portion of the cover glass may be exposed through an optical hole formed in a vehicle body panel (not shown) forming an external appearance of a vehicle body and the other portion of the cover glass may be arranged in the vehicle body. A waterproof member arranged around an opening may be further be provided between the cover glass 121 and the vehicle body so that water does not enter the vehicle through the optical hole formed in the vehicle body panel.

As shown in FIG. 3, the cover glass 121 may be formed to be greater than the lens 112, and may have a circular disk shape. The circular disk shaped cover glass 121 may be rotated by being connected with a rotary shaft 123 for transferring a rotary force of a motor 122 at the center. The optical device includes the cleaner 141 for accommodating a portion of the cover glass 121 in addition to an area where the optical module 110 is arranged. A cleaning solution is contained in the cleaner, and the cleaner vibrates the cleaning solution by supplying ultrasonic waves to the cleaning solution. As the cleaning solution is vibrated, a contaminant material attached to the cover glass 121 may be removed. At this time, the cleaning solution may include a water repellent coating solution so that no water drop may be formed on the cover glass 121.

The controller 130 determines contamination if optical information entering through the lens 112 is too weak or particles are sensed, and drives the motor 122 to rotate the cover glass 121. The contaminated portion arranged on the front surface of the optical module 110 may be dipped in the cleaning solution of the cleaner 141 and contaminants may be removed through ultrasonic vibration.

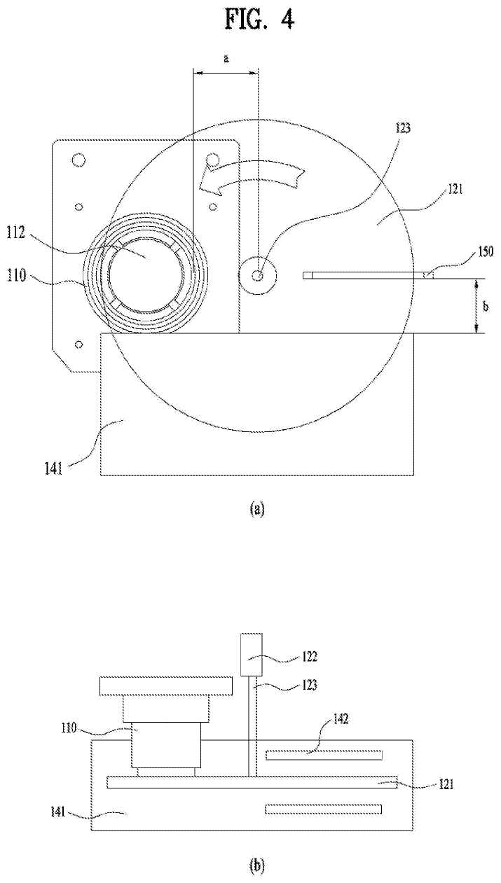

After the optical module 110 is cleaned by the cleaner 141, the cover glass 121 is rotated through rotation of the motor 122, and a wiper 142 may be arranged at an outlet of the cleaner 141 to remove a residual cleaning solution. FIG. illustrates a front view and a plane view illustrating the optical device 100 of FIG. 3. The optical device 100 may be arranged to be spaced apart from the outlet of the cleaner 141, or may be arranged at the outlet of the cleaner 141 in a single body with the outlet of the cleaner 141. A shown in (b) of FIG. 4, a wiper 142 may be arranged at both a front surface and a rear surface of the cover glass 121 to remove the cleaning solution thereon.

As shown in (a) of FIG. 4, the camera may be arranged to be spaced apart from a first distance ‘a’ at the center of the cover glass 121. The cleaner 141 may be arranged to be within a second distance ‘b’ shorter than the first distance ‘a’ at the center of the cover glass 121 such that a portion of cover glass 121, which is spaced apart from the center at a first distance ‘a’ or more, may be dipped in the cleaner 141.

The vehicle optical device of the present disclosure described as above may acquire exact information by removing particles that disturb acquisition of external information.

Also, since the user does not need to clean the optical device manually, convenience of the driver may be improved.

Since the cover is cleaned using multiple methods, a cleaning effect is high and the cover may be used semi-permanently.

Although the present specification has been described with reference to the accompanying drawing, it will be apparent to those skilled in the art that the present specification can be embodied in other specific forms without departing from the spirit and essential characteristics of the specification. The scope of the specification should be determined by reasonable interpretation of the appended claims and all change which comes within the equivalent scope of the specification are included in the scope of the specification.

What is claimed is:

1. A vehicle optical device comprising:
an optical module including a lens through which external light passes;
a cover glass arranged on a front surface of the lens;
a motor moving the cover glass;
a cleaner for accommodating a portion of the cover glass; and
a controller driving the motor to accommodate a portion of the cover glass, which is arranged on the front surface of the lens and contaminated, in the cleaner through rotation of the cover glass if the portion of the cover glass is contaminated.

2. The vehicle optical device of claim 1, wherein the cleaner includes:
a cleaning solution in which the cover glass is dipped; and
an ultrasonic module providing ultrasonic waves to the cleaning solution.

3. The vehicle optical device of claim 2, further comprising a wiper arranged to adjoin the cleaner, removing a cleaning solution remaining in the cover glass taken out from the cleaner.

4. The vehicle optical device of claim 3, wherein the wiper is arranged on both a front surface and a rear surface of the cover glass.

5. The vehicle optical device of claim 3, wherein the cleaning solution includes a water repellent coating solution.

6. The vehicle optical device of claim 1, further comprising:
a vehicle body panel forming an external appearance of a vehicle;
an optical hole formed in the vehicle body panel and formed at a position corresponding to the lens; and
a waterproof member arranged between the vehicle body panel and the cover glass, covering a circumference of the optical hole.

7. The vehicle optical device of claim 1, wherein the cover glass has a circular disk shape, the motor is fixed to a center of the cover glass, the optical module is arranged to be spaced apart from the center of the cover glass at a first distance, and the cleaner is arranged within the first distance from the center of the cover glass.
